(19) United States
(12) Patent Application Publication
(10) Pub. No.: US 2018/0112724 A1
(43) Pub. Date: Apr. 26, 2018

(54) MULTI-MODE CLUTCH SYSTEM WITH ELECTROMECHANICAL ACTUATION DEVICE

(71) Applicant: BorgWarner Inc., Auburn Hills, MI (US)

(72) Inventors: Calahan CAMPTON, Royal Oak, MI (US); John F. GUZDEK, Clarkston, MI (US); Jennifer KADLEC, West Bloomfield, MI (US)

(21) Appl. No.: 15/564,759

(22) PCT Filed: Apr. 6, 2016
(86) PCT No.: PCT/US2016/026154

§ 371 Date: Oct. 6, 2017

Related U.S. Application Data
(60) Provisional application No. 62/147,451, filed on Apr. 14, 2015.

(51) Int. Cl. F16D 41/16; F16D 23/12; F16D 41/04

(52) U.S. Cl. CPC F16D 41/16; F16D 2023/123; F16D 41/04; F16D 23/12

(57) ABSTRACT

The multi-mode clutch system (10) may include an actuator (14) and a cam output member (22) that is actuated by the actuator (14). The multi-mode clutch system (10) may further include a cam profile (78) on the cam output member (22) and a cam arm (26) being attached to the cam output member (22) wherein the cam arm (26) may be operatively associated with the actuator (14). Furthermore, the multi-mode clutch system (10) may include a pawl (42) and the pawl (42) may be able to rotate according to the position of the cam profile (78). The multi-mode clutch system (10) may be configured to allow multiple modes of operation between the pawl (42) and a driving member (66) according to different actuator (14) positions.

### CROSS-REFERENCE TO RELATED APPLICATION

This application is an International Patent Application claiming priority to US 35 U.S.C § 119(e) to U.S. Provisional Patent Application No. 62/147,451 filed on Apr. 14, 2015.

### FIELD OF THE DISCLOSURE

The present disclosure is generally related to clutches for automotive transmissions, and more particularly, relates to multiple mode clutch assemblies employed in the operation of such transmissions.

### BACKGROUND OF THE DISCLOSURE

Some machines such as, automobiles, trucks, vans, agriculture equipment, construction equipment, and other such vehicles may be equipped with a multi-mode clutch actuation device. Moreover, such machines may include an internal combustion engine containing a rotatable crankshaft configured to transfer power from the engine through a driveshaft in order to propel the machine. Furthermore, a transmission may be positioned between the internal combustion engine and the driveshaft to selectively control torque and speed ratios between the crankshaft and driveshaft.

In the case of a manually operated transmission, a manually operated clutch may be positioned between the internal combustion engine and the transmission to selectively engage and disengage the crankshaft from the driveshaft in order to facilitate shifting through the available transmission gear ratios. Alternatively, in an automatically operated transmission, a plurality of automatically actuated clutch units may be adapted to dynamically shift through the available gear ratios without requiring operator intervention. In some embodiments, the plurality of clutch units or clutch modules may be incorporated within automatic transmissions to facilitate the automatic shifting through the gear ratios.

Moreover, the transmission may incorporate numerous sets of gears and the various gears may be structurally comprised of sun gears, intermediate gears, such as planet or pinion gears supported by carriers, and outer ring gears. Moreover, specific transmission clutches may be associated with specific sets of the selectable gears within the transmission to facilitate the desired ratio changes.

An exemplary automatic transmission clutch module that is associated with first (low) and reverse gear ratios may be positioned near the front of the transmission and closely adjacent to the engine crankshaft. The clutch may have a driving member and a driven member disposed circumferentially about the driving member. Furthermore, the driving and driven members may be configured to operate in multiple modes. In one non-limiting example, the driving member may be drivingly rotatable in only one direction. Alternatively or additionally, the driving member may be drivingly rotatable in a plurality directions, however other modes and rotations may be possible. Moreover, the driving member may be selectively locked to the driven member via an engagement mechanism such as a roller, a sprag, a pawl or other known engagement mechanisms. The rotation of the driving member may be effective to directly transfer rotational motion from the engine to the driveline.

In some transmission systems, the driven member may be fixed to an internal case or housing of an associated planetary member of the automatic transmission. Under such circumstances, in a first configurational mode the driving member may need to be adapted to drive in one rotational direction, but freewheel in the opposite direction, in a condition referred to as overrunning. Those skilled in the art will appreciate that overrunning may be particularly desirable under certain operating states, such as when a machine is traveling downhill or coasting. Under such condition, the driven member may occasionally have a tendency to rotate faster than its associated driving member. Allowing the driving member to overrun the driven member may help provide protection against damage to the engine and/or transmission components.

In a second non-limiting mode, such as when a machine may be in reverse gear, the engagement mechanisms may be adapted for actively engaging in both rotational directions of the driving member, thus not allowing for an overrunning condition in either direction.

Automatic transmissions may include a plurality of gear sets to accommodate multiple gear ratios, and therefore the reliability of actuators used for automatically switching clutch modules between and/or among various available operating modes is a consistent design concern. As a result, much effort has been directed to finding ways to assure actuator reliability at competitive costs.

### SUMMARY OF THE DISCLOSURE

In accordance with one aspect of the present disclosure a multi-mode clutch system is disclosed. The multi-mode clutch system may include an actuator and a cam output member that is actuated by the actuator. The multi-mode clutch system may further include a cam profile on the cam output member and a cam arm being attached to the cam output member wherein the cam arm may be operatively associated with the actuator. Furthermore, the multi-mode clutch system may include a pawl and the pawl may be able to rotate according to the position of the cam profile. The multi-mode clutch system may be configured to allow multiple modes of operation between the pawl and driving member according to different actuator positions.

In accordance with another aspect of the present disclosure a multi-mode clutch system is disclosed. The multi-mode clutch system may include a first actuator and a second actuator. The multi-mode clutch system may further include a first cam output member and a second cam output member that are actuated by the first and second actuators. Additionally, the first cam output member may have a first cam profile and the second cam output member may have a second cam profile. Moreover, a first cam arm may be attached to the first cam output member and a second cam output member arm may be attached to the second cam output member, wherein the first cam arm is operatively associated with the first actuator and the second cam arm is operatively associated with the second actuator. The clutch assembly may further include a pawl that rotates about a pawl pivot point formed on a side plate that is disposed adjacent to the pawl. Furthermore, the pawl may be attached to the side plate by a feature, such as a pawl pin or other known feature, and the pawl may be configured to rotate according to the position of the first cam profile and the second cam profile. The multi-mode clutch system may further be configured to allow multiple modes of operation between the pawl and a driving member according to different actuator positions.

These and other aspects and features will be better understood when reading the following detailed description in conjunction with the accompanying drawings.

### BRIEF DESCRIPTION OF THE DRAWINGS

For further understanding of the disclosed concepts and embodiments, reference may be made to the following detailed description, read in connection with the drawings, wherein like elements are numbered alike and in which:

FIG. 1 is an end sectional view of a clutch assembly constructed in accordance with the present disclosure;

FIG. 2 is a side sectional view of the clutch assembly of FIG. 1 constructed in accordance with the present disclosure;

FIG. 3 is an end sectional view of another embodiment of the clutch assembly of FIG. 1 constructed in accordance with the present disclosure;

FIG. 4 is a side sectional view of the clutch assembly of FIG. 3 constructed in accordance with the present disclosure;

FIG. 5 is a flow chart illustrating an exemplary process or method which may be practiced in accordance with an embodiment of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

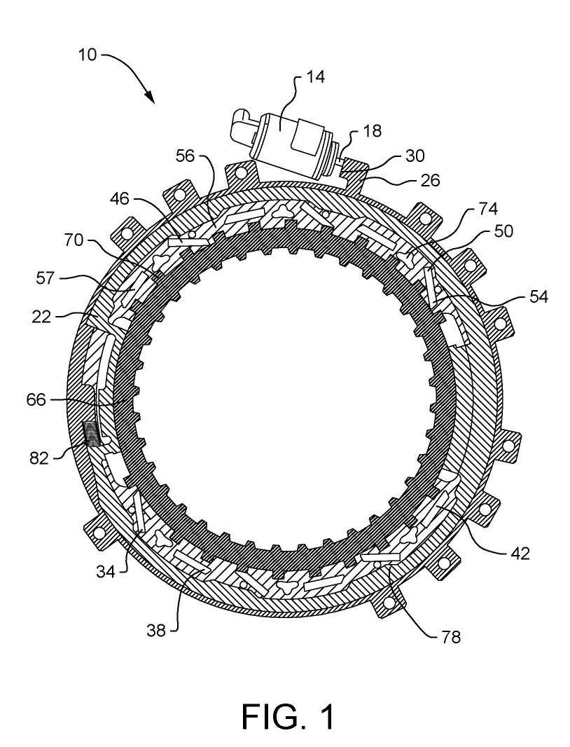

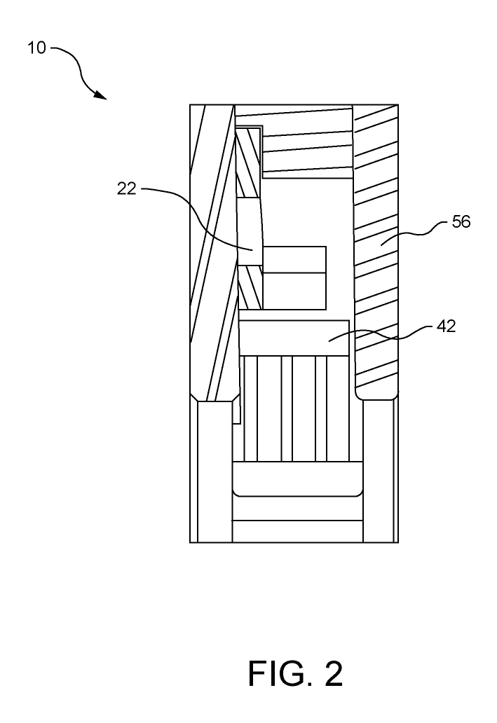

Turning now to the drawings, and with specific reference to FIGS. 1-2, a multi-mode clutch system constructed in accordance with the present disclosure is generally referred to by reference numeral 10. The multi-mode clutch system 10 is shown to include an actuator 14 including an armature 18. The actuator 14 may be a solenoid, magnetic device, hydraulic device, or other type of actuator 14. Moreover, the armature 18 may be moved upon actuation by the actuator 14, and such actuation may involve the armature 18 being extended away from the actuator 14.

The multi-mode clutch system 10 may also include a cam output member 22 and a cam arm 26. The cam arm 26 may be rigidly attached to the cam output member 22. Further the cam output member 22 may be substantially circular in shape. An arm face 30 may be located on the cam arm 26, and the armature 18 may be positioned to act upon the arm face 30 upon its actuation. In an embodiment, the armature 18 may impinge upon the arm face 30 upon the actuation of the armature 18. This impingement may cause the cam arm 26 to move. Accordingly, as the cam arm 26 may be rigidly attached to the cam output member 22, a motion of the cam arm 26 may produce a corresponding motion or rotation of the cam output member 22. In this manner, the cam arm 26 and cam output member 22 may move according to the motion of the actuator 14 and armature 18.

In addition to the above-mentioned components, the multi-mode clutch system 10 may also include a first pawl 34 and a second pawl 38. Each set of pawls 34, 38 may comprise one or more pawls 42. Each pawl 42 may rotate about a pawl pivot point 46, and may include a heel 50 and a toe 54. Moreover, a side plate 56 may be disposed adjacent to the pawls 42 and may house, contain or comprise each pawl pivot point 46. In some embodiments, each pawl 42 may rotate about a pawl pin 57, or an included pawl member or side plate member, passing through the side plate 56 and corresponding with the pawl pivot point 46.

The multi-mode clutch system 10 may also include a rotatable driving member 66. The driving member 66 may include a series of notches 70. In operation, the plurality of pawls 42 may rotate between an open position, a locked position, or any other desired position. An open position of the plurality of pawls 42 may allow the driving member 66 to rotate in a particular direction, or both directions, while a locked position of the plurality of pawls 42 may not allow driving member 66 rotation in a particular direction due to interference between one of the pawls 42 and the notches 70. In some embodiments the locked position may also be referred to as a ratcheting position. More specifically, in the locked position a toe 54 of the pawl 42 may interfere with a notch 70 of the driving member 66, thus preventing the driving member 66 rotating in a particular direction. As disclosed, each individual pawl 34, 38 is urged radially outwardly via a single spring 74. Although the use of a leaf-style spring is depicted, alternative spring types or even other biasing arrangements may be employed. For example, a pair of coil springs could be used; e.g., one for each pair of opposed pawls 34, 38.

The cam output member 22 may include a cam profile 78 that is able to interact with the first and second set of pawls 34, 38. The cam profile 78 may be shaped in such a manner such that it may alter the position of one or more sets of pawls 34, 38, between open and locked positions, based upon its own position. In some embodiments, the cam output member 22 may be able to rotate between various positions, and such rotation may be caused by a movement of the cam arm 26 by the actuator 14. Further, a return spring 82 may bias the cam output member 22 towards a particular direction or position, and such a direction or position may be in opposition to the direction of actuator 14 actuation. In this manner, the actuator 14 may influence the position of the sets of pawls 34, 38 through actuation, via a movement of the cam output member 22.

In operation, the actuator 14 may be able to move the armature 18 into various positions. In one embodiment, two positions are possible, although other positions and/or configurations are certainly possible. The multi-mode clutch system 10 may be arranged in such a way that different actuator 14 positions may have different effects on the positions of the first and second set of pawls 34, 38. In one non-limiting embodiment, two different actuator 14 positions allow two different positions of the first and second set of pawls 34, 38. Each actuator 14 position may thus correspond with a different cam output member 22 position and first and second set of pawls 34, 38 positions, and thus a different clutch mode of operation. However, other embodiments may include the actuation of only one pawl 42 or one set of pawls 34, 38.

In one embodiment, as shown in FIG. 1, the multi-mode clutch system 10 may be in a first mode of operation, wherein the first set of pawls 34 is in an open position, and the other set of pawls 38 is in a locked position. In such a mode, rotation of the driving member 66 is possible in one direction, but locked in the other.

In another position, the multi-mode clutch system 10 may be in a second mode of operation, wherein the first set of pawls 34 is in an open position, and the other set of pawls 38 is in an open position. In such a mode, driving member 66 rotation is possible in either direction. Other positions and modes, where the positions of the first and second sets of pawls 34, 38 each vary between open to locked positions, are certainly possible and may provide modes which allow rotation of the driving member 66 in both, one or no directions. Further, more than two sets of pawls 42 are possible, allowing additional modes of operation.

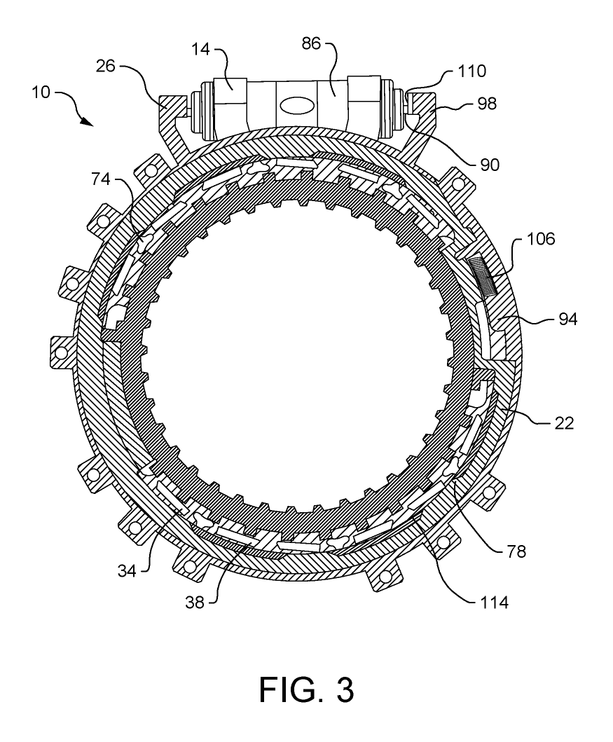

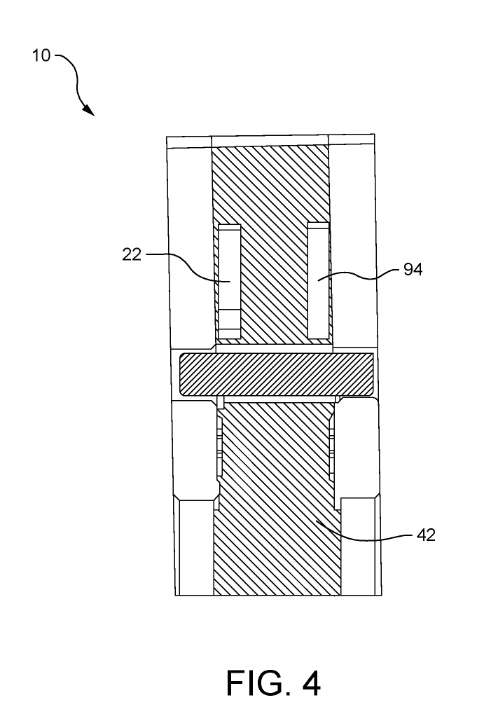

Turning to FIGS. 3 and 4, one non-limiting embodiment of the multi-mode clutch system 10 is shown having a second actuator 86, a second armature 90, a second cam output member 94 with a second cam arm 98, and a second cam return spring 106. Adding to the operation of the embodiment shown in FIGS. 1 and 2, the non-limiting example shown in FIGS. 3 and 4 further involves the second actuator 86 impinging upon, and moving, a second cam arm 98 with the second armature 90. The second armature 90 may act upon a second arm face 110 on the second cam arm 98. Such a movement may cause the second cam output member 94 to rotate to a different position. Upon this rotation, a second cam profile 114 may influence the position of one or more of the first and second set of pawls 34, 38, while the cam profile 78 of the cam output member 22 may also influence the position of one or more of the first and second set of pawls 34, 38.

In this manner, the combination of positions of the first and second actuators 14, 86 may influence the positions of the first and second cam output members 22, 94. Accordingly, this may influence the positions of one or more sets of pawls 34, 38. Such an arrangement allows combinations of pawl 42 settings for multiple modes of allowed driving member 66 rotation. In one embodiment, three modes of operation may be enabled, although in other embodiments, four modes of operation (or a different number of modes) may be enabled.

For example, in one mode, all sets of pawls 34, 38 may be set to an open position by one, neither or both of the cam output members 22, 94, allowing driving member 66 rotation in all directions. In another mode, one or the other set of pawls 34, 38 may be set to a locked position, preventing rotation in one direction. In yet another mode, both sets of pawls 34, 38 may be set to a locked position, preventing rotation in both directions.

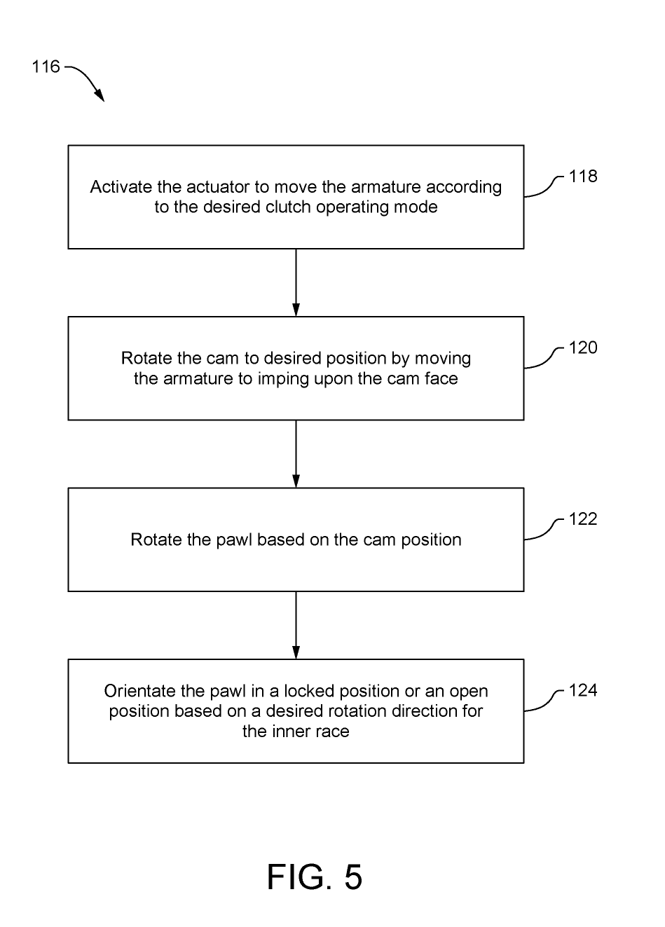

Referring now to FIG. 5, a method 116 of using the multi-mode clutch system 10 is shown. In a first block 118, the actuator 14 may be activated such that the actuator 14 causes the armature 18 to move according to the desired clutch operating mode. In a next block 120, the cam output member 22 may be rotated to a desired position by moving the armature 18 such that the armature 18 impinges upon the cam face 30. In a next block 122, the rotation of the cam output member 22 may interact with the pawl 42 and cause a rotation of the pawl 42. Furthermore, in the next block 124, the pawl 42 is rotated such that it may be orientated in a locked position or an open position. The pawl 42 orientation may depend on the desired rotation direction for the driving member 66.

It is to be understood that the foregoing is a description of one or more embodiments of the invention. However, the invention is not limited to the particular embodiment(s) disclosed herein. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

### INDUSTRIAL APPLICABILITY

In general, the multi-mode clutch of the present disclosure may be applied in a variety of industrial applications, including but not limited to, automobiles, trucks, vans, off-road vehicles, agriculture equipment, construction equipment, and other equipment of the type incorporating internal combustion engines, transmissions, and drivelines.

As disclosed herein, the multi-mode clutch assembly may incorporate an actuator with an armature that may be configured to interact with a cam output member of the clutch assembly. Furthermore, the interaction of the armature and the cam output member may create a movement and/or rotation of the cam output member. Moreover, the cam output member may be formed having a cam profile that is adapted to act on a pawl, or in some cases first and second sets of pawls. During operation, using the actuator in accordance with the present disclosure may create different effects on the positions of the cam output member and sets of pawls and as a result the clutch assembly may be able to operate is several different modes.

What is claimed is:

1. A multi-mode clutch system (10), comprising:
an actuator (14);
a cam output member (22) actuated by the actuator (14);
a cam profile (78) on the cam output member (22);
a cam arm (26) attached to the cam output member (22), wherein the cam arm (26) is operatively associated with the actuator (14); and
a pawl (42), wherein the pawl (42) is able to rotate according to the position of the cam profile (78), and the multi-mode clutch system (10) being configured to allow multiple modes of operation between the pawl (42) and a driving member (66) according to different actuator (14) positions.

2. The multi-mode clutch system (10) of claim 1, wherein the cam arm (26) has an arm face (30) and the cam arm (26) being rigidly attached to the cam output member (22).

3. The multi-mode clutch system (10) of claim 2, wherein an armature (18) is movably associated with the actuator (14) and the armature (18) being positioned to impinge upon the arm face (30) such that an actuation of the actuator (14) and the armature (18) causes a movement of the cam arm (26) and the cam output member (22) such that the cam output member (22) rotates between various positions, and a return spring (82) provides a cam output member (22) bias in a direction opposite to the rotation produced by the actuator (14) and the armature (18).

4. The multi-mode clutch system (10) of claim 1, wherein the pawl (42) may rotate about a pawl pivot point (46) formed on a side plate (56) disposed adjacent to the pawl (42) and the pawl (42) being attached to the side plate (56) by a pawl pin (57).

5. The multi-mode clutch system (10) of claim 4, wherein the pawl (42) is configured having a heel (50) and a toe (54) and the multi-mode clutch system (10) further comprises a first set of pawls (34) and a second set of pawls (38).

6. The multi-mode clutch system (10) of claim 5, wherein the pawl (42) rotates between an open position and a locked position and a pawl spring (74) biases the pawl (42) towards the locked position, the multi-mode clutch system (10) further comprises the driving member (66) being configured with a plurality of notches (70), and when the pawl (42) is in the locked position the toe 54 interferes with the plurality of notches (70) such that the driving member (66) is prevented from rotating in a particular direction.

7. The multi-mode clutch system (10) of claim 6, wherein the cam profile (78) interacts with the first and second set of pawls (34, 38) such that the position of the cam profile (78) causes the first and second set of pawls (34, 38) to rotate between the open and locked positions.

8. The multi-mode clutch system (10) of claim 7, wherein a first mode of operation positions the first set of pawls (34) in the open position and the second set of pawls (38) in the locked position such that the driving member (66) being able to rotate in one direction but locked in the other direction, and a second mode of operation positions the first set of pawls (34) in the open position and the second set of pawls (38) in the open position such that the driving member (66) being able to rotate in either direction.

9. A multi-mode clutch system (10) comprising:
a first actuator (14) and a second actuator (86);
a first cam output member (22) and a second cam output member (94) actuated by the first and second actuators (14, 86);
a first cam profile (78) on the first cam output member (22) and a second cam profile (114) on the second cam output member (94);
a first cam arm (26) attached to the first cam output member (22) and a second cam arm (98) attached to the second cam output member (94) wherein the first cam arm (26) is operatively associated with the first actuator (14) and the second can arm (98) is operatively associated with the second actuator (86); and
a pawl (42), wherein the pawl (42) rotates about a pawl pivot point (46) formed on a side plate (56) disposed adjacent to the pawl (42), the pawl (42) being attached to the side plate by a pawl pin (57) and being able to rotate according to the position of the first cam profile (78) and the second cam profile (114), and the multi-mode clutch system (10) being configured to allow multiple modes of operation between the pawl (42) and a driving member (66) according to different actuator positions.

10. The multi-mode clutch system (10) of claim 9, wherein the first cam arm (26) has a first arm face (30), the second cam arm (98) has a second arm face (110), the first cam arm (26) being rigidly attached to the first cam output member (22), the second cam arm (98) being rigidly attached to the second cam (94).

11. The multi-mode clutch system (10) of claim 10, wherein a first armature (18) being movably associated with the first actuator (14), a second armature (90) being movably associated with the second actuator (86), the first and second armatures (18, 90) being positioned to impinge upon the first and second arm faces (30, 110) respectively such that an actuation of the first and second actuators (14, 86) and the first and second armatures (18, 90) cause a movement of the first and second cam arms (26, 98) such that the first and second cam output members (22, 94) rotate between various positions and a first return spring (82) provides a first cam output member (22) bias in a direction opposite to the rotation produced by the first actuator (14) and the first armature (18) and a second return spring 106 provides a second cam output member (94) bias in a direction opposite to the rotation produced by the second actuator (86) and the second armature (90).

12. The multi-mode clutch system (10) of claim 9, wherein the pawl (42) being configured to have a heel (50) and a toe (54) and the multi-mode clutch system (10) further comprises a first set of pawls (34) and a second set of pawls (38).

13. The multi-mode clutch system (10) of claim 12, wherein the pawl (42) rotates between an open position and a locked position and a pawl spring (74) biases the pawl (42) towards the locked position, the multi-mode clutch system (10) further comprises a driving member (66) configured with a plurality of notches (70), and when the pawl (42) is in the locked position the toe (54) interferes with the plurality of notches (70) such that the driving member (66) is prevented from rotating in a particular direction.

14. The multi-mode clutch system of claim 13, wherein the first and second cam profiles (78, 114) interact with the first and second set of pawls (34, 38) such that the position of the first and second cam profiles (78, 114) rotates the first and second set of pawls (34, 38) between the open and locked positions.

15. The multi-mode clutch system of claim 14, wherein a first mode of operation positions the first and second set of pawls (34, 38) in the open position such that the driving member (66) is able to rotate in all directions, a second mode of operation positions one of the first and second set of pawls (34, 38) in the locked position and one of the first and second set of pawls (34, 38) in the open position such that the driving member (66) being able to rotate in a single direction, and a third mode of operation positions the first and second set of pawls (34, 38) in the locked position such that the rotatable driving member (66) being unable to rotate in any direction.
